(19) United States
(12) Patent Application Publication
(10) Pub. No.: US 2026/0223812 A1
(43) Pub. Date: Aug. 6, 2026

(54) Reinforced mobile pasture fence

(71) Applicant: Johan Cremers, Geilenkirchen (DE)

(72) Inventors: Johan CREMERS, Geilenkirchen (DE); Gergor BAUMGART, Viersen (DE)

(21) Appl. No.: 19/466,003

(22) Filed: Jan. 30, 2026

(30) Foreign Application Priority Data
Jan. 31, 2025 (DE) 102025103594.6

(51) Int. Cl. A01K 3/00; E04H 17/04

(52) U.S. Cl. CPC A01K 3/001; A01K 3/005; E04H 17/05

(57) ABSTRACT

A fence netting for a mobile pasture fence includes multiple horizontal netting strands which are arranged parallel to one another and extend over the entire horizontal length of the fence netting, and the fence netting furthermore includes multiple netting strips which run transversely to the netting strands, are arranged parallel to one another and extend from the top netting strand to the bottom netting strand, wherein the netting strands and strips are connected to one another at the crossing points of the netting strands with the netting strips, and the netting strands are formed of a fibre-reinforced plastic, wherein the fibres extend over the entire length (L) of the netting strips.

### CROSS REFERENCE TO RELATED APPLICATION

This application claims priority to German Patent Application Serial No. 10 2025 103 594.6, filed January 31, 2025, the contents of which are incorporated herein by reference.

### BACKGROUND OF THE INVENTION

The invention concerns a fence netting for a mobile pasture fence, wherein the fence netting comprises multiple horizontal netting strands which are arranged parallel to one another and extend over the entire horizontal length of the fence netting, and the fence netting furthermore comprises multiple netting strips which run transversely to the netting strands, are arranged parallel to one another and extend from the top netting strand to the bottom netting strand, wherein the netting strands and strips are connected to one another at the crossing points of the netting strands with the netting strips, and the netting strands consist at least of a flexible plastic yarn. The invention also concerns a mobile pasture fence comprising at least one fence netting and at least two fence posts.

Mobile pasture fences are used in the agricultural sector, for example for fencing in animals. Further areas of use of such mobile pasture fences are as boundaries in skiing regions, on construction sites or in the private sector. It is also possible for the mobile fences to be permanently erected. The mobile fences consist of fence posts which are attached to the ground with anchor pins, and a fence netting. The fence netting consists of horizontally running netting strands, and netting strips running transversely thereto. The netting strands usually consist of twisted or braided plastic monofilament, preferably polyethylene (PE), polypropylene (PP), or polyamide (PA). The netting strips running transversely thereto consist either of the same material or also of polyamide. Also, the netting strips may consist of an extruded plastic profile, e.g. polyamide. Alternatively, polypropylene or high-density polyethylene (HDPE) may also be used for these plastic profiles. In comparison with known variants with exclusively twisted or braided plastic monofilament as both netting strips or also as netting strands, extruded netting strands have the advantage that the fence is slightly more stable when erected, and sagging of the fence netting between the fence posts is reduced. The disadvantage of these extruded plastic strips however is that the fence netting, and hence also the entire mobile pasture fence, is very cumbersome and heavy when rolled up. This is due above all to the own weight of the extruded plastic strips. The extruded plastic strips are indeed stiffer than twisted or braided plastic monofilament, but as a whole however they are still fairly soft. Thus, although the standing strength of the fence is improved, the individual netting meshes of the fence netting are however still so soft and untensioned that small animals can become trapped therein when attempting to slip through the fence netting. In the case of sagging fence netting which is operated as an electric fence with an electric voltage, sagging of the fence netting can also lead to contact of the current-conducting strands with the ground or with plants or objects arranged close to the fence. This leads to an undesirable voltage drop at the electric fence. Also, the higher material weight of the strips is significant, so the total weight of the fence netting is greater. Together with the greater thickness of the netting strips and the associated greater volume of the rolled-up fence netting, this results in poorer transportability of the fence netting or of the mobile pasture fence. This is disadvantageous in particular for the use of the fence in areas with difficult access, where for example it is necessary to transport the mobile pasture fence manually or by helicopter.

### SUMMARY OF THE INVENTION

It is therefore the object of the present invention to improve the stiffness of mobile pasture fences and at the same time improve the transportability of the mobile pasture fence.

This object is achieved by a fence netting for a mobile pasture fence, wherein the fence netting comprises multiple horizontal netting strands which are arranged parallel to one another and extend over the entire horizontal length of the fence netting, and the fence netting furthermore comprises multiple netting strips which run transversely to the netting strands, are arranged parallel to one another and extend from the top netting strand to the bottom netting strand, wherein the netting strands and strips are connected to one another at the crossing points of the netting strands with the netting strips, and the netting strands consist at least of a flexible plastic yarn. The invention is characterized in that the netting strips consist of a fibre-reinforced plastic, wherein the fibres extend over the entire length of the netting strips.

According to the invention, the netting strips are made of a fibre-reinforced plastic. Because the reinforcing fibres extend over the entire length of the netting strips, a very high bending stiffness of the netting strips is achieved. Because the fibres extend over the entire length of the netting strips, the reinforcing fibres are endless fibres. These endless fibres should be distinguished from short fibres and long fibres, wherein short fibres may have a length up to 5 mm and long fibres a length between 5 and 25 mm. In contrast, endless fibres extend over the entire component length. Because of the use of endless fibres, in comparison with the use of short or long fibres, a significantly higher bending stiffness and a far greater weight reduction can be achieved. Also, in comparison with short or long fibres, endless fibres reduce the total volume of netting strips required for the necessary bending stiffness, so that the netting strips according to the invention can be made particularly thin. Firstly, the fence netting thus becomes more stable. In particular, the individual meshes of the fence netting are stabilized and held open. This reduces the risk of trapping animals. With the fence netting according to the invention, the finished pasture fence as a whole is more stable, whereby also any current-conducting strands would not touch the ground so readily and cause a voltage drop. Because of the reduced weight of the netting strips and the reduced volume of the netting strips in comparison with the prior art, in rolled-up state the fence is significantly more compact and lightweight, and can therefore be transported more easily. This constitutes a great advantage especially for transport in areas with difficult access, such as for example alpine pastures.

The fibre-reinforced netting strips increase the stability of the pasture fence so that it is possible to increase the spacing of the fence posts in the pasture fence. For the same fence length and same fence stability, therefore, fewer fence posts are required, which makes the pasture fence as a whole lighter and more favourable, and further reduces the packing volume.

Because of the netting strips according to the invention, it is also possible to make the pasture fence higher without jeopardizing the stability and standing strength of the fence. This is particularly advantageous for use as a wolf netting, which must have a high height for the desired protective effect.

Preferably, the netting strips run vertically. The vertically running netting strips in this case form a right angle with the horizontally running netting strands. It is however also conceivable that the netting strips are arranged at an angle other than 90° to the horizontally running netting strands.

Preferably, the netting strands and netting strips are connected together at the crossing points by a fastening means. Preferably, this fastening means is a common plastic overmoulding of the crossing netting strand and netting strip. With this fastening means, the netting strands and netting strips can be connected together into a fence netting in a very simple and cost-efficient manner. Preferably, HDPE or PP is used for the plastic overmoulding. These plastics adhere well to the plastic materials of the netting strands and strips, and thus ensure a particularly stable connection between the netting strands and strips.

Preferably, at least one of the upper horizontally running netting strands comprises a current-conducting filament, preferably a metal wire. The bottom netting strand here does not comprise a current-conducting filament. Thus the mobile pasture fence can be placed under electrical voltage so as to reinforce the fencing effect for the fenced-in animals, and at the same time the risk of voltage drop from grounding can be further reduced. The term "bottom netting strand" in this case refers to the horizontally running netting strand which is situated closest to the ground when the pasture fence is in the erected state. The term "upper netting strands" in this case refers to all netting strands from the top netting strand to the penultimate netting strand which is arranged directly above, adjacent and parallel to the bottom netting strand. It is conceivable that the current-conducting filament is made from a material other than a metal wire. In particular, any current-conducting material is in principle conceivable here.

The netting strips are preferably cylindrical and have a circular or elliptical cross-section perpendicular to their longitudinal cylinder axis. This shape is particularly advantageous for the production of netting strips using a pultrusion process. This pultrusion process allows the production of fibre-reinforced plastic profiles with endless fibres in a particularly simple and cost-saving method.

Preferably, the plastic of the horizontal netting strands is a twisted or braided plastic monofilament. Preferably, this consists of polyethyelene, polypropylene or polyamide.

According to at least one further embodiment, the fibres of the fibre-reinforced plastic are glass fibres, carbon fibres, basalt fibres, hemp fibres and/or flax fibres. For cost reasons, glass fibres are preferred as reinforcing fibres in the netting strips. It is however also quite conceivable to use other fibre materials or a combination of fibre materials. Hemp fibres or flax fibres offer the advantage that they can be sourced sustainably and have a better recycling capability. Thus the CO2 balance of the fence netting can be improved.

According to a further embodiment, the matrix plastic of the fibre-reinforced plastic is a duroplastic or a thermoplastic material. For duroplastic materials, polyester, vinyl ester, polyurethane or epoxy resin systems are preferred. It is however also conceivable to use all other duroplastics. Preferred thermoplastic materials are polyamide, polyamide-6 (PA6), polyamide-12 (PA12), polymethylmethacrylate (PMMA) or polymethylmethacrylate 9 (PMMA9). It is however also conceivable to use any other thermoplastic material. In the selection of plastics, particular attention should be paid to the combination of matrix plastic and reinforcing fibre. Here, it is particularly important that the selected plastic allows a good wetting of the reinforcing fibres. Preferably, the netting strips can be produced in a pultrusion process. For thermoplastic matrix plastics, either a conventional pultrusion process or an in-situ pultrusion process is possible. In the latter case, the better adhesion of the matrix plastic to the reinforcing fibres leads to an even stiffer netting strip and hence a further improvement in the material properties. In-situ pultrusion is possible for example with polyamide-6, polyamide-12 or PMMA9 in combination with various endless fibres. As an alternative to a conventional pultruded material, a pre-produced towpreg (already activated) may also be used for the netting strips. A towpreg, also called a prepreg, comprises preformed endless fibres which have already been impregnated with a matrix material and then serve as a semifinished product. The towpreg can be brought directly into the desired form and then hardened by heat treatment, possibly in an autoclave. Preferably, the towpreg is already sheathed with polyethylene, polyamide or polypropylene. This pre-product can be formed directly into netting strips and hardened without the need for a pultrusion process. This leads in particular to a significant simplification of the production of the fence netting, since no pultrusion plant is required in the direct production line with a fence netting production machine.

According to at least one further embodiment, the fibres of the fibre-reinforced plastic have a proportion of 50 - 85 percent by volume of the total volume of the fibre-reinforced plastic. Particularly preferably, the fibres of the fibre-reinforced plastic have a proportion of 65 - 85 percent by volume of the total volume of the fibre-reinforced plastic. Only with this fibre proportion can the necessary bending stiffness and reduction in weight and volume be achieved. This high fibre proportion can only be achieved with the use of endless fibres. The fibre proportions of fibre-reinforced components with short or long fibres lie significantly below this value and accordingly do not have the advantageous values for bending stiffness and material weight.

Because of the reinforcing fibres, the netting strips have a higher bending stiffness than the prior art. It is however also conceivable to achieve a corresponding bending stiffness with a lower fibre content in combination with stiffer fibres or a stiffer matrix plastic, or achieve this with a greater thickness of the netting strips. In this case, it must be ensured that the selected material combination and netting strip thickness do not entail any weight disadvantage for the fence netting.

According to a further embodiment, the weight of each netting strip is 4 - 6 g. Preferably, the weight of each netting strip is 4.5 - 5.5 g, particularly preferably 5 g. These weight values relate to a netting strip length of 1.05 m and thickness of 1.5 mm. A comparable netting strip from the prior art weighs around 8 g. In addition to this weight reduction, because of the stiffer netting strips of the invention, fewer netting strips are required per length unit of the fence netting for a stable pasture fence. Also, because of the smaller diameter of the netting strips, less material is required for connecting the netting strips and netting strands. Thus for the fence netting in total, a significant weight saving of 15 - 35% is possible compared with the prior art.

According to a further embodiment, the thickness of the netting strips is 1 - 3 millimetres. Preferably, the thickness of the netting strips is 1.5 - 2.0 millimetres, particularly preferably 1.7 - 1.9 millimetres. With this netting strip thickness, in comparison with polyamide strips of the prior art, a thickness reduction of around 50% can be achieved. Thus even in rolled-up state, the fence netting is decisively more compact. This volume saving again has an advantageous effect on the transportability of the fence netting.

The smaller thickness also has a positive effect on the fastening means. In the case of a plastic overmoulding, an overmoulding can be achieved with less overmoulding material.

According to a preferred embodiment, the netting strips have a sheathing made of plastic, preferably polyethylene, polyamide or polypropylene, which covers the entire cylindrical casing surface of the netting strips. In profiles of fibre-reinforced plastic with endless fibres, it may occur that individual fibre ends separate from the matrix plastic. These constitute a corresponding risk of injury when touched. In order to minimise this risk, a sheathing may be used. This sheathing preferably covers the entire cylindrical casing surface of the netting strips. Preferably, the end faces of the cylindrical netting strips are also coated with the sheathing. The end faces constitute the cut surfaces of an endlessly pultruded, cylindrical profile which is cut into individual netting strips of the desired length. If both the casing surface and also the end faces are provided with the sheathing, the entire surface of the netting strip is coated with the sheathing. Because of the coating with the sheathing, any protruding fibre ends are encased by the sheathing and can no longer protrude from the plastic and hence cause injury. The sheathing preferably has a thickness of 0.1 - 0.25 mm.

Alternatively, the sheathing may also have a thickness of 0.5 - 1 mm. Thus the netting strip admittedly becomes heavier, but also much stiffer. Preferably, this embodiment is combined with a higher proportion of reinforcing fibres. Particularly preferably, this embodiment is additionally or alternatively combined with a thicker netting strip. Preferably, the netting strip thickness in this embodiment is 1.5 - 3 mm. Preferably, the fibres of the fibre-reinforced plastic have a proportion of 65 - 85 percent by volume of the total volume of the fibre-reinforced plastic. The particularly high stiffness of the netting strips in this embodiment leads to a particularly stable tensioning of the netting meshes. This greatly reduces the danger of wild animals becoming trapped in the fence netting. In some cases, in this embodiment, depending on feature combination, there may be only a small or even no weight advantage in comparison with known fence netting, but this is compensated by the high stability of this embodiment. In particular, this variant is also suitable for a more permanent fencing which needs to be moved less often.

According to a further embodiment, the sheathing of the netting strips is coloured and/or reflective. This increases the visibility of the fence netting. While a coloured design can increase visibility in daylight, a reflective design increases visibility even in poor light conditions. The combination of a coloured and reflective design can improve visibility in almost all light conditions. In order to make the sheathing coloured, it is advantageous to add dye only to the sheathing plastic instead of dying the entire matrix plastic, since because of the thinner sheathing layer, a smaller quantity of the comparatively costly dye is sufficient to colour the entire netting strip. The same applies to additives which have a reflective effect in the plastic. If a towpreg which is already sheathed with polyethylene, polyamide or polypropylene or another plastic, is used to produce the netting strips, it is conceivable to mix the additives for the coloured and/or reflective effect directly into this sheathing of the towpreg. It is however also possible to provide the towpreg with a second coloured and/or reflective sheathing.

According to a further embodiment, at least intermediate one netting strand is arranged between two adjacent netting strips, which strand runs parallel to the netting strips and transversely to the horizontal netting strands, and is connected to the horizontal netting strands at the crossing points. Preferably, in this embodiment, the mutual spacing of the netting strips is greater so that with the additional intermediate netting strands, the same mesh size of the fence netting is obtained. In other words, in this embodiment, not every transversely running connection of the netting strands is configured as a reinforced netting strip. Rather, some of the transverse connections are configured as simple intermediate netting strands which may consist of the same material as the horizontally running netting strands. A corresponding fence netting with effectively fewer netting strips, in comparison with exclusive use of netting strips with closer spacing, has a slightly reduced stability. This can however be compensated by a cost advantage in production, since fewer of the comparatively costly netting strips are required. This variant may be used in particular for applications in which stability and bending stiffness are less relevant, but at the same time a particularly lightweight and compact fence netting is required. In this embodiment, it is conceivable, for example, with a constant mesh width, to configure every second, third, fourth, fifth or sixth transversely running connection as a netting strip and the transverse connections in-between as intermediate netting strands. By adapting the mesh width and by selection of the proportions of netting strips and intermediate netting strands in the fence netting, an optimum balance can be achieved between stability, costs and packing size for the respective concrete application case.

The object according to the invention is also achieved by a mobile pasture fence at least comprising at least one fence netting according to any of the preceding embodiments and at least two fence posts. The fence netting is attached to the fence posts, and the fence posts are anchored in the ground by anchor pins or other fastening means. In order to achieve a further weight saving and to configure the pasture fence so as to be more stable and lighter, it is also conceivable that the fencing posts consist partially of a fibre-reinforced composite material. It is here preferred if the fibre-reinforced composite material of the fence posts also comprises endless fibres. Preferably, the fence posts consist of a hollow profile with round cross-section. Preferably, the hollow profile consists completely of the fibre-reinforced composite material with the endless fibres. Preferably, the hollow profile of the fence post also has an external sheathing of polyamide, polypropylene or polyethylene. Here again, any protruding fibres can thus be covered and embedded so as to reduce the risk of injury. It is also conceivable here to configure the fence posts so as to be coloured or reflective. This can also be achieved by the introduction of a dye or a reflective material into the sheathing. It is also conceivable that the fence post consists of a translucent plastic and an illumination device is arranged in the interior of the hollow profile. This, in addition to a coloured and/or reflective configuration of the netting strips, can improve the visibility of the mobile pasture fencing.

### BRIEF DESCRIPTION OF THE DRAWINGS

Further advantages, objectives and properties of the present invention are explained in the following description of the appended figures. Similar components may carry the same reference signs in the various embodiments. In the drawings:

FIG. 1 shows an overview illustration of the pasture fence 1

FIG. 2 shows a detail illustration of the netting strip 23 and the netting strands 22 of the fence netting 2

FIG. 3a shows a cross-sectional illustration of the fibre-reinforced netting strip 23 with circular cross-section

FIG. 3b shows a cross-sectional illustration of the fibre-reinforced netting strip 23 with elliptical cross-section

FIG. 4 shows a perspective illustration of the fibre-reinforced netting strip 23

FIG. 5 shows an overview illustration of the pasture fence 1 with netting strips 23 and intermediate netting strands 25.

### DETAILED DESCRIPTION OF THE INVENTION

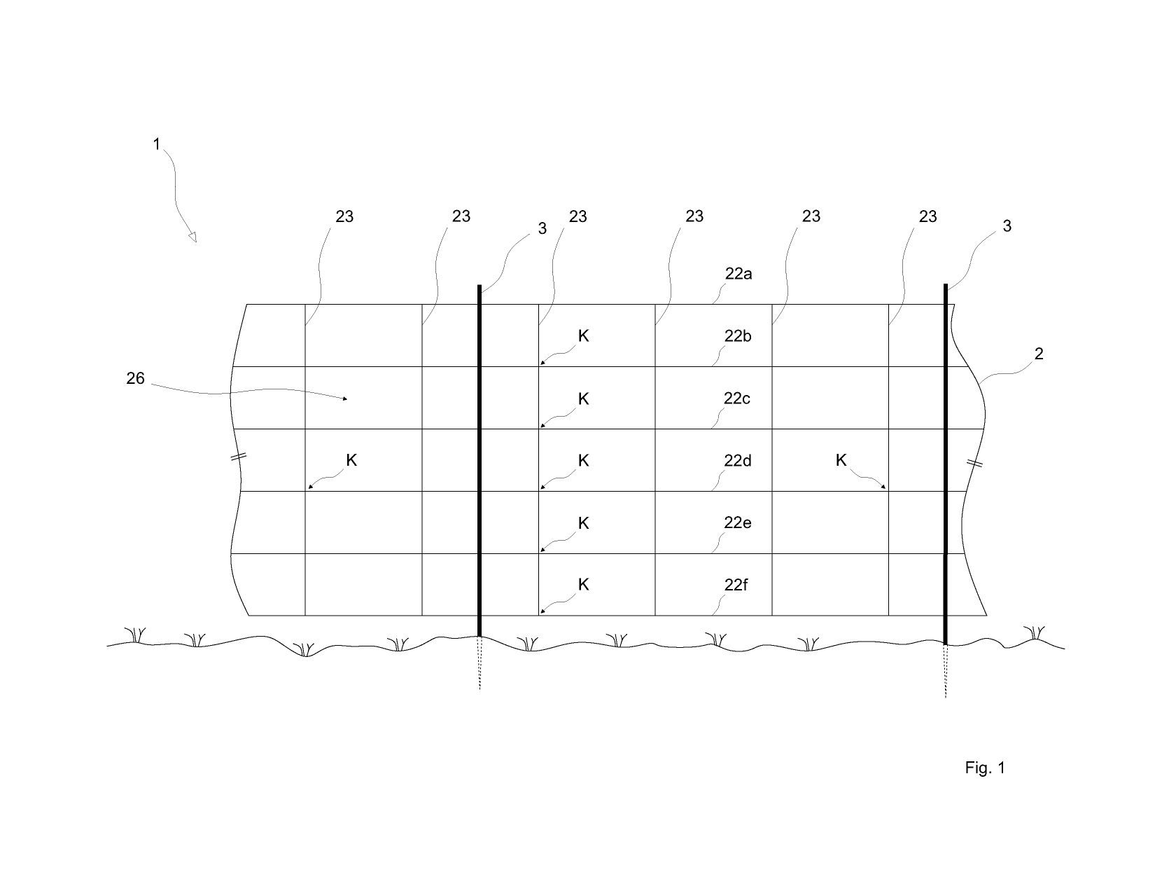

FIG. 1 shows a schematic illustration of a mobile pasture fence 1. The mobile pasture fence 1 comprises a fence netting 2 and fence posts 3. The fence netting 2 consists of horizontally running netting strands 22a - 22f and netting strips 23 which run perpendicularly thereto and are preferably vertical in this embodiment. The netting strands 22 and netting strips 23 cross at respective crossing points K. The netting strands 22 and netting strips 23 are connected to one another at the crossing points K. The fence netting 2 is thus tensioned and formed by the netting strands 22 and netting strips 23. In this erected state, the top horizontal netting strand 22a is situated at the top end of the fence (viewed vertically), and the bottom netting strand 22f is situated at the bottom end of the fence netting 2 which is closest to the ground. Preferably, the pasture fence 1 is positioned such that the bottom netting strand 22f does not touch the ground. The penultimate netting strand 22e is arranged directly above the bottom strand 22f in the vertical direction. This penultimate netting strand, together with the top netting strand 22a and all netting strands 22 arranged between the top netting strand 22a and the penultimate netting strand 22e, form the upper netting strands 22a - 22e. These upper netting strands 22a - 22e preferably comprise a current-conducting filament, while the bottom netting strand 22f preferably has no current-conducting filament.

Because of their crossings, the netting strands 22 and netting strips 23 form fence meshes 26. The fence meshes 26 are preferably quadrilateral. With a vertical configuration of the netting strips 23 and a horizontal arrangement of the netting strands 22, the netting meshes 26 are preferably rectangular or square. The fence netting 22 is attached to the fence posts 3. Preferably, the fence netting 2 is hooked onto the fence posts. Alternatively, the fence posts may be threaded alternately through the fence meshes, and the fence netting 2 fastened to the fence post 3 only at an upper end and in some cases also a lower end. A stable pasture fence 1 can be achieved firstly by the use of many fence posts 3 at small distances from one another. However, this has the disadvantage that the comparatively costly fence posts 3 increase the total price of the pasture fence 1 and also increase the total weight of the pasture fence 1. Depending on the spacing of the adjacent fence posts 3 and the ground conditions, it may be difficult to achieve a strong tensioning of the fence netting 2 between adjacent fence posts 3. With the netting strips 23 according to the invention in the fence netting 2 according to the invention, the desired stability can be achieved even in these cases.

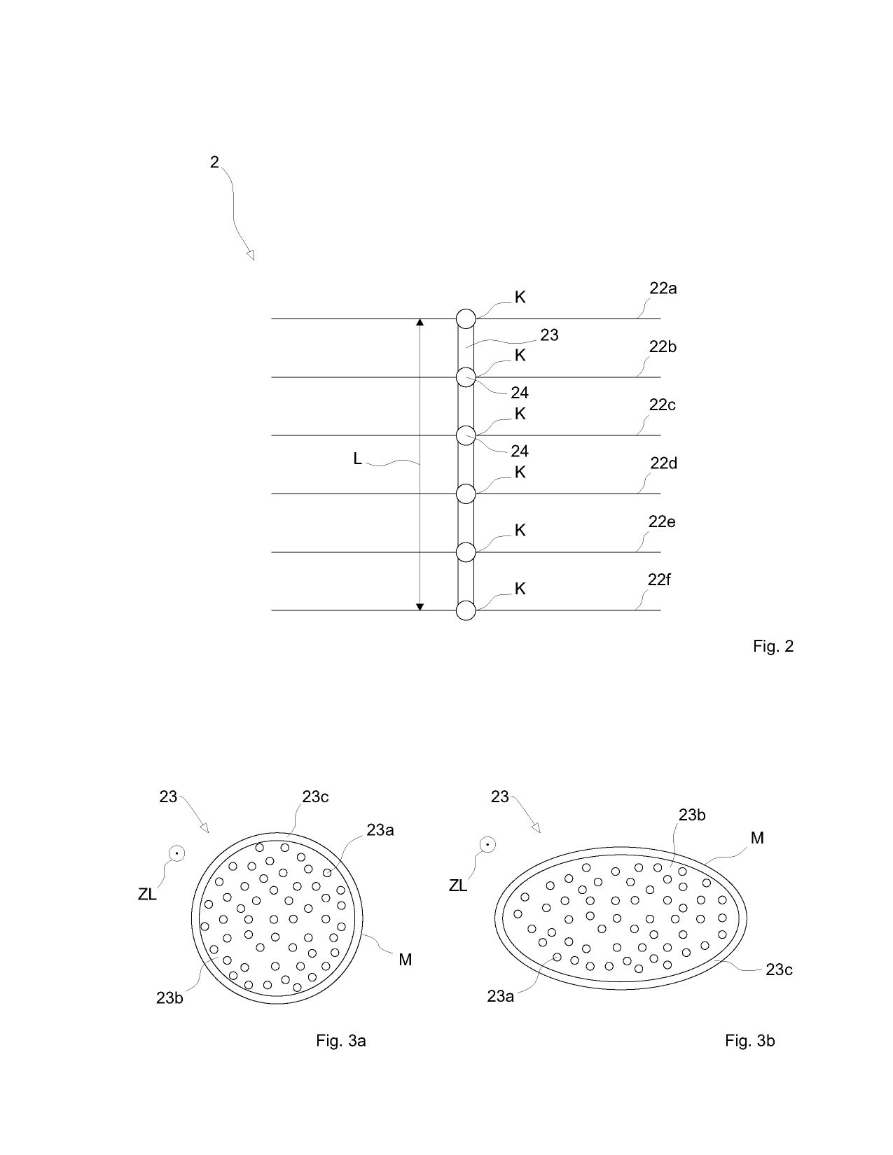

FIG. 2 shows a detail image of the horizontal netting strands 22a-22f and a vertically running netting strip 23. The netting strip 23 extends from the top netting strand 22a down to the bottom netting strand 22f. Preferably, the total length L of the netting strip 23 corresponds to the distance from the top netting strand 22a to the bottom netting strand 22f. It is however also conceivable that the netting strip 23 protrudes to some degree beyond the top netting strand 22a and/or the bottom netting strand 22f. The netting strip 23 is fastened to the respective netting strand 22a - 22f at the crossing points K of the respective netting strip 23 with the different netting strands 22a - 22f. Preferably, this fastening at the crossing point K is achieved by a common overmoulding of the netting strip 23 and the corresponding netting strand 22 with a plastic. However, other fastening means are also conceivable. In particular, conceivable options would also include bonding, hot welding or weaving/knotting the netting strip to the corresponding netting strand. The reinforcing fibres (not shown here) of the fibre-reinforced plastic of the netting strip 23 extend over the total length L of the netting strip 23 and preferably run parallel to the longitudinal axis of the netting strip 23.

FIG. 3a shows a cross-section of the netting strip 23 in plan view. The netting strip 23 is cylindrical and in this embodiment has a circular end face. The longitudinal cylinder axis ZL is arranged perpendicularly to the paper plane in the illustration of FIG. 3a. The longitudinal cylinder axis ZL of the cylindrical strip 23 is preferably arranged vertically in the fence netting 2 when the pasture fence is erected. It is however also conceivable to orient the netting strips 23 not precisely vertically but at another angle to the horizontally running netting strands 22. In the cross-sectional illustration, the fibre-reinforced plastic is shown with the reinforcing fibres 23a and the matrix plastic 23b. The reinforcing fibres 23a are here oriented parallel to the longitudinal cylinder axis ZL of the netting strip 23. The reinforcing fibres 23a extend over the entire length of the netting strip 23 along the longitudinal cylinder axis ZL. The matrix plastic 23b surrounds the reinforcing fibres 23a completely so that they are embedded in the matrix plastic 23b. The matrix plastic 23b reinforced with the reinforcing fibres 23a has overall a round cylindrical shape. This cylinder shape is preferably provided with a sheathing 23c on its casing surface M. The sheathing 23c may be applied either exclusively on the casing surface M or also additionally on the end faces G of the cylindrical netting strip 23. It is however also conceivable to configure the netting strip 23 without sheathing 23c. This embodiment of the netting strip 23 with circular end face constitutes a particularly effective design for achieving a greatest possible volume proportion of fibre-reinforced plastic in a smallest possible diameter of the netting strip 23.

FIG. 3b also shows a cross-section through the cylindrical netting strip 23 perpendicularly to the longitudinal cylinder axis ZL. In this embodiment, the netting strip 23 has an elliptical end face G. In this embodiment, the netting strip 23 thus has a generally elliptical cylinder shape. In this case too, the fibre-reinforced plastic of the netting strip 23 comprises reinforcing fibres 23a and a matrix plastic 23b in which the reinforcing fibres 23a are embedded. Optionally, the netting strip 23 may also have a sheathing 23c which is preferably applied to the entire casing surface M of the elliptical cylinder and in some cases also onto the end faces G, which are arranged perpendicularly thereto, of the elliptical cylinder. In this embodiment too, the reinforcing fibres 23a are arranged parallel to the longitudinal cylinder axis ZL of the netting strip 23. The reinforcing fibres 23a here extend over the entire length of the netting strip 23 along the longitudinal cylinder axis ZL.

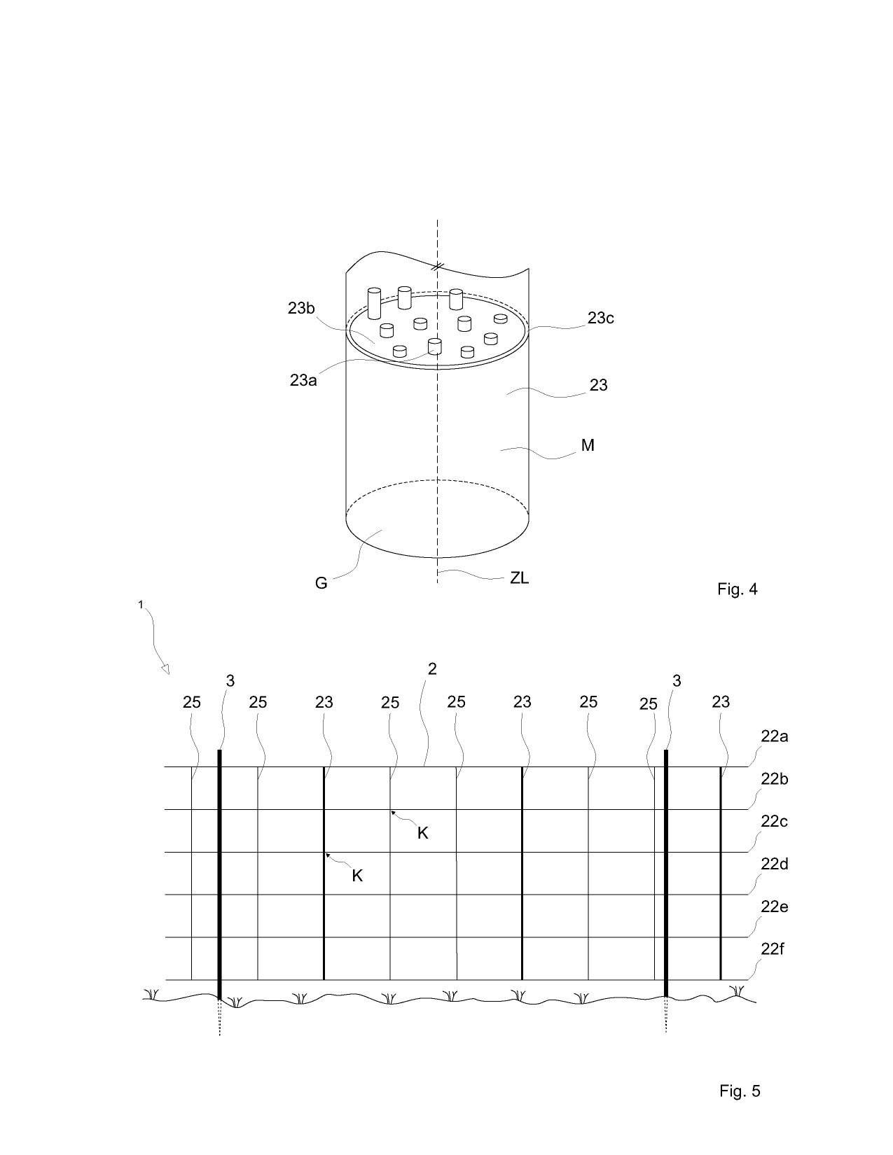

FIG. 4 shows a perspective illustration of the lower end of the netting strip 23. The cylindrical netting strip 23 here comprises the fibre-reinforced plastic with reinforcing fibres 23a and the matrix plastic 23b. The reinforcing fibres 23a are all embedded in the matrix plastic 23b parallel to the longitudinal cylinder axis ZL. The casing surface M of the cylinder is preferably covered with the coating 23c. At the lower end of the netting strip 23 is the end face G, which for example is created by cutting an endless pultruded string. Alternatively, it is also conceivable to form the netting strip 23 directly as a cylindrical profile of the desired length along the longitudinal cylinder axis ZL. In one embodiment, the end face G may also be provided with the sheathing 23c. In this case, the entire cylinder surface of the netting strip 23 is provided with the sheathing 23c. This is advantageous in particular since, at the cut edges of an endless pultruded profile, the reinforcing fibres 23a extend directly up to the cut edge of the end face G. In this case, it can occur particularly easily that individual reinforcing fibres 23c fray and protrude out of the matrix plastic 23b, and thus constitute a risk of injury when touched. Coating the end faces with the sheathing 23c prevents this.

FIG. 5 shows an illustration of a mobile pasture fence 1 with a fence netting 2 and fence posts 3 in an embodiment with intermediate netting strands 25. The fence netting 2, with the horizontally running netting strands 22a - 22f and the netting strips 23 running transversely thereto, corresponds to the previous embodiments. In addition to these transversely running netting strips 23, in this embodiment however intermediate netting strands 25 are also provided. These intermediate netting strands 25 run parallel to the netting strips 23. They also connect all horizontally running netting strands 22a - 22f together. As with the netting strips 23, the intermediate netting strands 25 are connected to the respective netting strands 22a - 22f at their crossing points K. This takes place preferably with the same fastening means 24 with which the netting strips 23 are also connected to the netting strands 22. If different materials and plastic types are used for the netting strip 23 and intermediate netting strands 25, it is however also conceivable to use different fastening means here in order to achieve a best possible connecting effect. In this embodiment, the original netting mesh size of the fence netting 2, delimited by the horizontal netting strands 22a - 22f and the netting strips 23 running horizontally thereto, is divided into smaller netting meshes by the intermediate netting strands 25. In the exemplary embodiment shown here, two intermediate netting strands 25 are arranged between two parallel and adjacent netting strips 23, so that by the arrangement of the intermediate netting strands 25, the mesh width is reduced to one-third of the original mesh width. Also however, any other arrangement and size distribution is possible. For example, it is conceivable that only one, or also three, four, five or more intermediate netting strands 25 is/are arranged between two adjacent netting strips 23.

The applicant reserves the right to claim all features disclosed in the application documents as essential to the invention insofar as these are novel individually or in combination in relation to the prior art. It is furthermore pointed out that the individual figures also describe features which may be advantageous in themselves. The person skilled in the art will immediately perceive that a specific feature described in a figure may also be advantageous without the use of further features from this figure. Furthermore, the person skilled in the art will perceive that advantages may also arise from a combination of multiple features shown in individual or in different figures.

### LIST OF REFERENCE SIGNS

1 Pasture fence

2 Fence netting

3 Fence post

22 Netting strands

22a Top netting strand

22f Bottom netting strand

23 Netting strips

23a Fibres

23b Matrix plastic

23c Sheathing

24 Fastening means

25 Intermediate netting strand

K Crossing point

L Length of netting strips

ZL Longitudinal cylinder axis

M Casing surface

G End face

1. A fence netting for a mobile pasture fence, wherein the fence netting comprises multiple horizontal netting strands which are arranged parallel to one another and extend over the entire horizontal length of the fence netting, and the fence netting furthermore comprises multiple netting strips which run transversely to the netting strands, are arranged parallel to one another and extend from the top netting strand to the bottom netting strand, wherein the netting strands and strips are connected to one another at the crossing points of the netting strands with the netting strips, and the netting strands are comprised of a flexible plastic yarn,
wherein
the netting strips are comprised a fibre-reinforced plastic, wherein the fibres extend over the entire length of the netting strips.

2. The fence netting according to claim 1,
wherein
the fibres of the fibre-reinforced plastic are selected from the group consisting of glass fibres, carbon fibres, basalt fibres, hemp fibres, flax fibres and combinations thereof.

3. The fence netting according to claim 1 ,
wherein
the matrix plastic of the fibre-reinforced plastic is a duroplastic or a thermoplastic material.

4. The fence netting according to claim 1,
wherein
the fibres of the fibre-reinforced plastic comprise a proportion of 50 - 85% by volume of the total volume of the fibre-reinforced plastic.

5. The fence netting according to claim 1,
wherein
the weight of each netting strip is 4 - 6 g.

6. The fence netting according to claim 1 ,
wherein
the thickness of the netting strips is 1 - 3 mm.

7. The fence netting according to claim 1,
wherein
the netting strips have a sheathing made of a plastic which covers the entire cylindrical casing surface of the netting strips.

8. The fence netting according to claim 7,
wherein
the sheathing of the netting strips is coloured and/or reflective.

9. The fence netting according to claim 1,
wherein
at least one intermediate netting strand is arranged between two adjacent netting strips, which strand runs parallel to the netting strips and transversely to the horizontal netting strands, and is connected to the horizontal netting strands at the crossing points.

10. A mobile pasture fence at least comprising at least one fence nettingaccording to claim 1 and at least two fence posts.

11. The fence netting according to claim 2,
wherein
the matrix plastic of the fibre-reinforced plastic is a duroplastic or a thermoplastic material.

12. The fence netting according to claim 2,
wherein
the fibres of the fibre-reinforced plastic have a proportion of 50 - 85% by volume of the total volume of the fibre-reinforced plastic.

13. The fence netting according to claim 2,
wherein
the thickness of the netting strips is 1 - 3 mm.

14. The fence netting according to claim 3,
wherein
the thickness of the netting strips is 1 - 3 mm.

15. The fence netting according to claim 4,
wherein
the thickness of the netting strips is 1 - 3 mm.

16. The fence netting according to claim 5,
wherein
the thickness of the netting strips is 1 - 3 mm.

17. The fence netting according to claim 7,
wherein
the sheathing is made of plastic selected from the group consisting of PE, PA and PP.
